(19) United States
(12) Patent Application Publication
(10) Pub. No.: US 2007/0117510 A1
(43) Pub. Date: May 24, 2007

(54) System for responsive to detection, acoustically signalling desired nearby devices and services on a wireless network

(75) Inventor: Martin Elixmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/562,532

(22) PCT Filed: Jul. 1, 2004
(86) PCT No.: PCT/IB04/51099

§ 371 Date: Dec. 28, 2005

(30) Foreign Application Priority Data
Jul. 4, 2003 (EP) 03102019.1

(51) Int. Cl. H04B 7/00

(52) U.S. Cl. 455/41.2

(57) ABSTRACT

The invention relates to a distributed electronic system having at least one device G1 able to be perceived (2) and at least one device G2 capable of perception (3), which latter has an acoustic output. To enable devices of a type being looked for by a user to be more easily perceived, G1 (2) and G2 (3) co-operate with one another by automatic intercommunication in such a way that the user learns at any time by means of audible signals which types of device are located in the area surrounding him. In an embodiment, G2 comprises a perception profile storing desired device-types for comparison in a Bluetooth service discovery process. G2 can be part of a headphone or hearing aid, and the audio sequences can be edited by an application linked to G2 via the ad-hoc interface.

The present invention relates to a distributed electronic system that makes it possible for devices on a wireless network (wireless LAN, WLAN) to be perceived audibly.

Wireless networks in spatially confined areas (so-called local area networks or LANs) are used in an enormous variety of different fields. One application is, for example, computer LANs, on which a plurality of computers and a plurality of peripheral devices such as printers, scanners, projectors and so on are combined. LANs of this kind are widely used in companies, for example. They generally have a plurality of access points (APs) via which a user can link a WLAN-compatible device into the network and can thus use the company's mainframe computer, for example. In addition to this, the use of generally available peripheral devices such as printers, scanners, OHP projectors and so on is made possible by linking them too into the network and thus enabling them to be addressed by various users. This makes it possible for, for example, the peripheral devices to be installed in fixed locations in conference rooms, in which case a person giving a talk merely has to link his laptop into the network and cause the laptop to enter into communication with the peripheral device.

The technique of wireless communication is also known for the ad-hoc networking of devices. Wireless connections, under the Bluetooth standard for example, allow all the devices that are prepared to communicate to made contact on an ad-hoc basis, provided they are within the relevant radio-dictated range. When the devices communicate, a network and a device address are transmitted, but these do not tell the user whether a device of a given type that he is looking for is situated in his vicinity.

This being the case, the problem arises that, of a plurality of devices situated within radio range, the right one has to be selected. If, for example, a user who has a laptop is looking for a printer in a building with which he is not familiar, it is of interest to him to find the printer that is the shortest distance away from the point at which he is currently located and not some other device.

The present-day discovery frameworks such as, for example, Universal Plug&Play (UpnP) make it possible for devices and services that are reachable over the network or are available on the network to be discovered. It is not, however, possible with this prior art to restrict the discovery of devices and services to devices and services that are desired.

In the ad-hoc mode, even local area networks operating to IEEE standard 802.11 support the direct linking together of devices into an ad-hoc network. However, even under these circumstances, the user does not learn whether a device of a given type for which is looked is situated in the area surrounding him.

Many mobile and fixed devices used in home entertainment electronics and communications electronics and in the field of personal computers are nowadays fitted with technology for making wireless ad-hoc connections to enable them to be linked in to a digital ad-hoc communications network.

From JP 9081176, it is known for messages—such as fresh e-mails received for example—to be announced acoustically as soon as a person enters a room. The advantage of techniques of this kind is that the user is informed without having to look in a given direction or to ask whether messages have been received.

U.S. Pat. No. 6,549,142 discloses a method in which a person entering a room is detected and, as a tie-up with this event, a search is made for the occurrence of earlier events (such as the receipt of e-mails, for example) and these are then announced acoustically.

The teaching of both documents makes earlier events perceptible acoustically as soon as a triggering event (a person entering a room) occurs. Communication on a network and the perception of network components is not disclosed in either of the documents.

Where there are a plethora of devices capable of interaction in the area surrounding a user, it is an object of the present invention to enable those devices in which a user is interested to be perceived audibly at the receiver end by means of ad-hoc communication.

This object is achieved by virtue of the fact that a device to be discovered (also referred to in what follows as a device able to be perceived) emits a signal that is able to be detected by a searching device (also referred to below as a device capable of perception), whereupon the searching device emits an acoustic signal provided the type of device of which the device to be discovered is a representative, which type is found from the signal from the device concerned, is present in the perception profile of the searching device.

The present invention relates to a distributed electronic system able to be networked on an ad-hoc basis, having at least one device G1 able to be perceived and at least one device G2 capable of perception, wherein G2 emits an acoustic detection signal relating to G1 as soon as G1 makes its way into the reception zone of G2 and the type of which G1 is a representative is present in G2's perception profile.

The distributed system according to the invention comprising at least one device G1 able to be perceived and at least one device G2 capable of perception makes the device G1 capable of ad-hoc communication acoustically perceptible provided the latter is within radio range of the device G2 capable of perception and the user's perception profile “permits” the perception of the device in question.

In the simplest case, the devices able to be perceived are represented by their generic designations, i.e. by a set (G1, G2, G3, . . . , Gn). The perception profile of a user is likewise represented by a set of generic device designations (W1, W2, W3, . . . , Wm) which designate which devices a user wishes to perceive. Connected with each individual perception requirement Wi, 1≦i≦m, there is an acoustic perception signal Si which sounds when a device of type Wi is perceived, i.e. when the user is approaching a device able to be perceived Gj, 1≦j<n , where Gj must equal Wi, i.e. the type of the device that is perceived is part of the perception profile. The audible signal may, for example, be the spoken generic name (“printer”, etc.) or some other sound that, to the user, is characteristic of the type of device.

If there is not a match between the devices able to be perceived and the user's perception profile, no perception occurs, i.e. no signal to the relevant effect sounds. It is therefore only the devices that are able to be perceived and are present in the perception profile which are signaled acoustically, i.e. the system filters out devices that are not appropriate.

The perception preferably takes place automatically as soon as a user having an appropriate perception profile comes into radio range. For this purpose, the distributed system according to the invention is preferably fitted with transmit/receive interfaces. In preferred distributed electronic systems according to the invention, a plurality of devices able to be perceived communicate automatically with a device capable of perception, within the transmission range, via transmit/receive interfaces.

In other preferred embodiments of the distributed electronic systems according to the invention, a device may be both able to be perceived and capable of perception simultaneously.

The perceiving device (device capable of perception) may advantageously be so arranged that only the user hears the acoustic signals for the perception of given devices.

Distributed electronic systems according to the invention of this kind in which the perceiving device is part of wireless headphones or a wireless hearing aid, are preferred in accordance with the invention.

In another preferred embodiment of the distributed electronic system according to the invention, the perceiving device can be linked up, via the ad-hoc communications interface, to a computer application with which the perception profile and/or the audio sequences can be edited.

In this way, the user may search only for printers or only for projectors, as dictated by the particular situation, and is not overwhelmed with acoustic signals. It is also possible in this way for the acoustic signals to be individually adjusted to the user's wishes.

In another preferred embodiment of the distributed electronic system according to the invention, the perceiving device has remote-control functions for devices able to be perceived, these preferably being for START, STOP, REPEAT and NEXT, which functions can likewise be called up at the perceived device via the ad-hoc wireless interface.

As a result of this, the user is able to access the perceived device, and control it, directly, without laboriously first having to make a command connection to the perceived device.

In other preferred embodiments, the perceiving device may receive data from the perceiving device and may convert the data. In this way, an audio file for example may be received and played back. Preferred distributed electronic systems according to the invention are characterized in that, being part of headphones, the perceiving device is also capable of receiving and playing back audio data that is transmitted from the perceived device.

As a similar facility to the communications interface via which the perception function and the perception signals can be changed, the system according to the invention may also comprise a loading function to allow updating for new types of device etc. In this case, the distributed electronic systems according to the invention that are preferred are ones in which the perceiving device is equipped with a loading function to allow its type definition that is required for the perception to be updated.

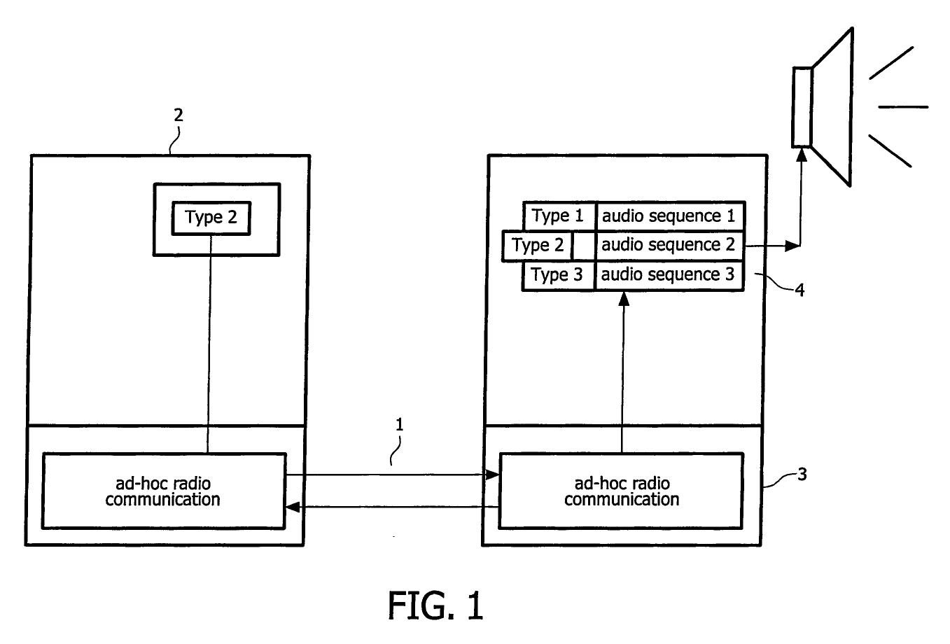

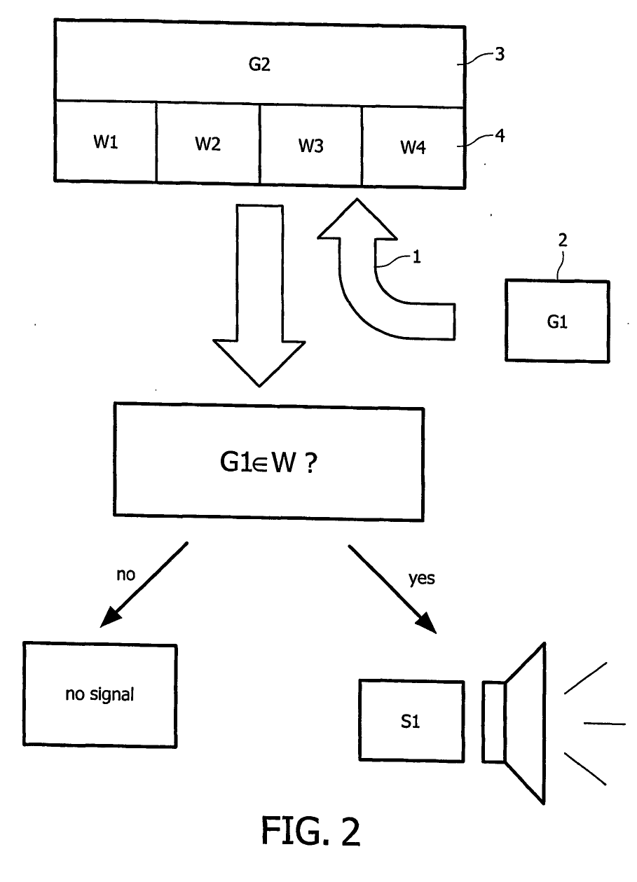

These and other aspects of the invention are apparent from and will be elucidated with reference to FIGS. 1 and 2.

FIG. 1 shows a device able to be perceived (2) whose generic name (Type 2) is transmitted via a transmit/receive interface (1) to a device capable of perception (3). The device capable of perception (3) has a perception profile (4) in which the generic name of the device able to be perceived (2) is stored. Because the type of the device perceived (2) is part of the perception profile (4) of the device capable of reception (3), the associated audio sequence 2 is reproduced acoustically.

FIG. 2 shows a flow chart for the detection of a device able to be perceived (2) by a device capable of perception (3). The device capable of perception (3) has a perception profile (4) that comprises the items W1, W2, W3 and W4. Via its transmit/receive interface (1), the device able to be perceived (2) transmits its generic name to the device capable of perception (3). The latter checks whether the generic name G1 is part of its perception profile (4). If the type of the device perceived (2) is part of the perception profile (4), the associated signal S1 sounds and if it is not, no signal is reproduced acoustically.

1. A distributed electronic system able to be networked on an ad-hoc basis, having at least one device G1 able to be perceived (2) and at least one device G2 capable of perception (3), wherein G2 emits an acoustic detection signal relating to G1 as soon as G1 makes its way into the reception zone of G2 and the type of which G1 is a representative is present in G2's perception profile.

2. A distributed electronic system as claimed in claim 1, wherein, within the transmission range, a plurality of devices able to be perceived (2) communicate automatically with a device capable of perception (3) via transmit/receive interfaces (1).

3. A distributed electronic system as claimed in claim 2, wherein a device may be both able to be perceived and capable of perception simultaneously.

4. A distributed electronic system as claimed in claim 2 or 3, wherein the perceiving device (3) is part of wireless headphones or a wireless hearing aid.

5. A distributed electronic system as claimed in claim 2 or 3, wherein the perceiving device (3) can be linked up, via the ad-hoc communications interface, to a computer application with which the perception profile and/or the audio sequences can be edited.

6. A distributed electronic system as claimed in any of the foregoing claims, wherein the perceiving device (3) has remote-control functions for devices able to be perceived (2), these preferably being for START, STOP, REPEAT and NEXT, which functions can likewise be called up at the perceived device (2) via the ad-hoc wireless interface.

7. A distributed electronic system as claimed in any of the foregoing claims, wherein, being part of headphones, the perceiving device (3) is also capable of receiving and playing back audio data that is transmitted from the perceived device.

8. A distributed electronic system as claimed in any of the foregoing claims, wherein the perceiving device (3) is equipped with a loading function to allow its type definition that is required for the perception to be updated.

9. An appliance G2 (2) with a receiving device, a control device with a perception profile, and a signaling device for providing acoustic signals, wherein the control device is designed for initiating the generation of an acoustic signal upon a recognition of a device type by the receiving device, said device type being laid down in the perception profile.
